(19) United States
(12) Patent Application Publication
(10) Pub. No.: US 2014/0346213 A1
(43) Pub. Date: Nov. 27, 2014

(54) BALANCED GAS FASTENING TOOL

(71) Applicant: SOCIETE DE PROSPECTION ET D'INVENTIONS TECHNIQUES SPIT, Bourg-les-Valence (FR)

(72) Inventors: Jean-Luc Simonin, Barcelonne (FR); Guy Jaillet, La Roche de Glun (FR)

(73) Assignee: SOCIETE DE PROSPECTION ET D'INVENTIONS TECHNIQUES SPIT, Bourg-les-Valence (FR)

(21) Appl. No.: 14/112,888

(22) PCT Filed: Apr. 19, 2012
(86) PCT No.: PCT/IB2012/051985

§ 371 Date: Jun. 19, 2014

(30) Foreign Application Priority Data
Apr. 20, 2011 (FR) 1101238

(51) Int. Cl. B25C 1/08; B25F 5/02

(52) U.S. Cl. CPC B25C 1/08; B25F 5/02
USPC 227/10

(57) ABSTRACT

The tool comprises an inner combustion engine, in a housing, for propelling a piston for driving a fastening member, a casing for receiving a fuel cell as a source of energy of the engine, a handle for handling the tool, with a trigger for actuating the tool and a casing for receiving a battery as the electrical supply source of the tool, the handle being connected to the housing of the engine, and extending substantially perpendicular to an axis of the housing. On the side opposed to the housing of the engine, the handle is connected to an arm for receiving the fuel cell and the electrical supply battery.

This invention relates to a so-called gas fastening tool, i.e. comprising, in a housing, an inner combustion engine for propelling a piston for driving a fastening member, the engine being associated with a source of energy consisting in a combustible gas (fuel) cell. Such a tool further comprises an electric supply battery as well as a gripping, handling and shooting handle on which an actuating trigger for the tool is mounted.

For a long time, the problem has existed of the balancing of such tools, being imperfectly balanced. Indeed, when an operator holds a tool, tightening with one hand the handle, he finds it difficult to handle the tool and to stabilize it in a shooting position. This applies for tools wherein the cell casing extends parallel to the axis of the housing, between the housing and the handle, or for tools wherein the fuel cell is located inside the handle. For a tool to be correctly balanced, its centre of gravity should be substantially positioned in a point of the handle onto which the operator applies his forefinger, that is the trigger.

The Applicant had already proposed in FR 2,774,934, a tool having its centre of gravity closer to the ideal balancing point being the trigger, with a cell casing extending parallel to the handle and offset along the axis of the housing with respect to such a handle.

As the Applicant has tried to go even further in overcoming such a balancing problem, they propose to-day a novel improved tool in this respect.

Thus, the present application relates to a gas fastening tool comprising an inner combustion engine, in a housing, for propelling a piston for driving a fastening member, a casing for receiving a fuel cell as a source of energy for the engine, a handle for handling the tool, with a trigger for actuating the tool and a casing for receiving a battery as the electrical supply source for the tool, the handle being connected to the housing of the engine, and extending substantially perpendicular to an axis of the housing, said tool being characterized in that, on the side opposed to the housing of the engine, the handle is connected to an arm for receiving the fuel cell and the electrical supply battery.

Otherwise stated, the casings for receiving the cell and the battery are arranged in this arm connected to the handle, but on the side opposed to that through which it is connected to the housing of the engine.

Thus, when an operator has engaged the cell and the battery in this arm remote from the engine, for being able to use the tool, the cell and the battery act as a ballast for shifting the centre of gravity outside the housing of the engine, in an area even closer to the trigger than the centre of gravity of the prior art tools.

Through some minor adaptations, the area of the trigger and the centre of gravity should be able to be confused.

Thanks to the invention, the ergonomics of the tool of this invention is remarkable.

Thanks to the invention, the negative influence of the recoil of the tool upon shots, on the electronic components of the tool remote from the engine, including those associated with the battery and the means for injecting fuel from the cell into the combustion chamber of the engine, is significantly reduced.

In a preferred embodiment of the tool of this invention, a magazine is provided for supplying fastening members and the receiving arm for the cell and the battery forms a bridge extending between the handle and this magazine.

This invention will be better understood from the following description of the preferred embodiment of the tool, with reference to the appended drawing, wherein:

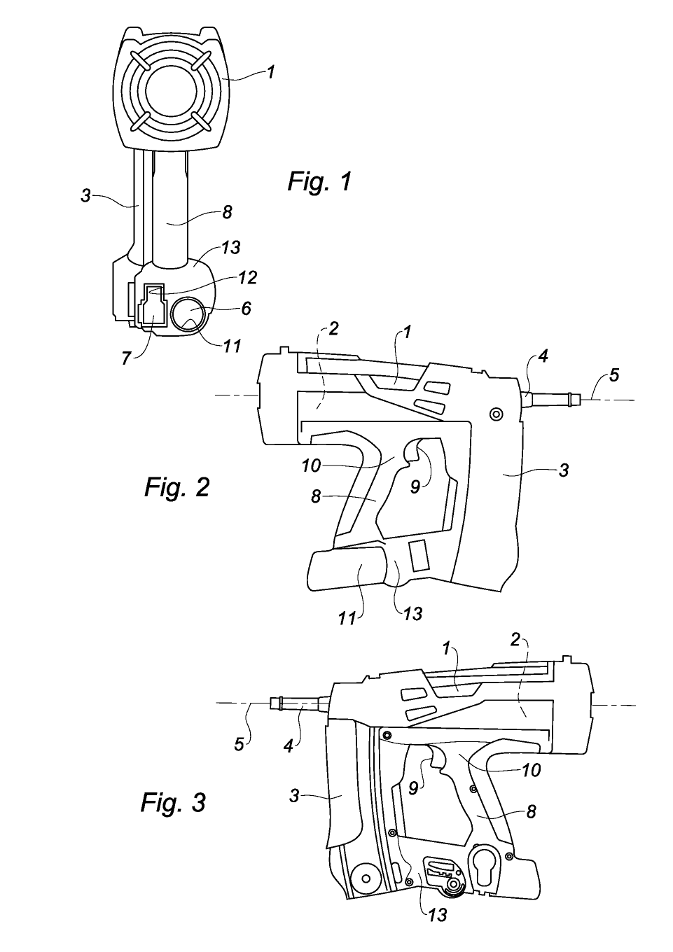

FIG. 1 is a rear end view of the tool;

FIG. 2 is a right side view of the tool and

FIG. 3 is a left side view of the tool.

The tool shown on the figures comprises a housing 1 wherein an inner combustion engine 2 is arranged, with a combustion chamber intended for containing a mixture of air and fuel, the ignition of which results in a piston being propelled, acting to drive a fastening member coming from a supply magazine 3, the fastening member being intended for becoming anchored into a support material, at the outlet of a tip guide 4 extending at the front of the housing 1. All those components of the gas fastening tools are perfectly known to those skilled in the art and they thus have not been all shown on the drawing.

The housing of the tool has an axis 5, along which the driving piston moves and, in the tip guide 4, the fastening members.

Supplying the combustion chamber of the engine 2 with fuel occurs via an injection member, for example, a solenoid valve, from a cell of combustible gas 6 (fuel).

When there is one present in the tool, as shown in the drawing, this is the source of energy of the engine.

For running, the tool an electric power supply is also needed, for example a battery 7, as shown already introduced in the tool in the drawing.

The tool comprises a tool gripping and handling handle 8.

It extends from the housing and outside it, substantially perpendicular to the axis 5, even so slightly bent on it. The handle 8 is also used for shooting, through an actuating trigger 9 mounted on it, in the area 10 of its connection to the housing 1.

The fastening tool is outstanding since, when a fuel gas cell and a battery are mounted therein, the tool gravity centre is substantially located in this connection area 10 where the trigger 9 is located.

Indeed, the cell receiving casing 11 and the battery receiving casing 12 are arranged in an arm 13 connected to the handle 8 on the opposed side to the housing 1, this arm extending substantially parallel to the axis 5.

The arm 13 extends between the handle 8 and the supply magazine 3 extending, with its receiving casing, substantially perpendicular to the axis 5, the arm 13 forming a bridge between the two. It should be noticed that the arm 13 extends here slightly beyond and behind the handle 8.

When a cell 6 and a battery 7 are located on the arm 13, they are used as a ballast for moving the gravity centre outside the housing 1, in the trigger area 10.

The tool that has just been described is ergonomic and the influence of the tool recoil, upon shots, on the electronic components is quite low.

Moreover, the gas cell being located under the handle, and not parallel and at the front thereof anymore, the handle could have been advanced in order to move the user's hand closer to the gravity centre and to better balance the tool and thus to reduce the hardness of use.

1. A gas fastening tool comprising an inner combustion engine, in a housing, for propelling a piston for driving a fastening member, a casing for receiving a fuel cell, as a source of energy of the engine, a handle for handling the tool, with a trigger for actuating the tool and a casing for receiving a battery as the electrical supply source of the tool, the handle being connected to the housing of the engine, and extending substantially perpendicular to an axis of the housing, said tool being characterized in that, on the side opposed to the housing of the engine, the handle is connected to an arm for receiving the fuel cell and the electrical supply battery, so that the gravity centre of the tool in use is situated in the area of the trigger.

2. The fastening tool according to claim 1, wherein a magazine is provided for supplying fastening members and the arm for receiving the cell and the battery forms a bridge extending between the handle and this magazine.
